(19) United States
(12) Patent Application Publication
(10) Pub. No.: US 2010/0231396 A1
(43) Pub. Date: Sep. 16, 2010

(54) SYSTEM AND METHOD FOR MONITORING PARTS USED BY A SCREENING MACHINE

(75) Inventor: Ronald S. Tump, Whitewater, WI (US)

Correspondence Address: FOLEY & LARDNER LLP, 777 EAST WISCONSIN AVENUE, MILWAUKEE, WI, 53202-5306, US

(73) Assignee: SCHENCK AccuRate, Inc.

(21) Appl. No.: 12/404,875

(22) Filed: Mar. 16, 2009

(51) Int. Cl. G08B 21/00

(52) U.S. Cl. 340/652

(57) ABSTRACT

A system for monitoring a plurality of screen panels configured for use in a materials screening process is provided. The system includes a plurality of screen panels. Each screen panel is coupled to a radio frequency identification (RFID) circuit which is configured to alter its behavior if its associated screen panel breaks.

### BACKGROUND

The present application relates to the field of materials screening processes and equipment such as a screening machine. The present application more particularly relates to a system and method for monitoring parts used by a screening machine.

The handling and processing of particulate materials (e.g., gravel, rocks, iron ore, etc.) often includes a materials screening process during which the materials are fed through apertures in one or more screen panels to screen (e.g., sort, filter, separate, size, etc.) the material or parts of the material. Depending on the material and a number of other factors, the screen panels are subject to high levels of wear, particularly around the apertures. It is typically difficult to detect failure of screen panels unless the screening machine is emptied and visually inspected. Even then, due to the number of apertures on a screen panel and the number of screen panels in a screening machine, it is often challenging to know whether any particular screen panel is broken or too worn.

### SUMMARY

One embodiment relates to a system for monitoring a status of a screen panel configured for use in a materials screening process. The system includes a screen panel configured for use in a material screening process. The system further includes an antenna coupled to the screen panel and configured to receive first electromagnetic energy. The system yet further includes a processing circuit coupled to the screen panel and the antenna, the processing circuit configured to receive a signal from the antenna regarding the first electromagnetic energy and to cause the transmission of second electromagnetic energy in response to the receipt of the signal.

Another embodiment relates to a screen panel configured for use in a materials screening process. The screen panel includes a mesh structure and an antenna embedded within the mesh structure. The screen panel further includes a processing circuit coupled to the mesh structure and the antenna. The antenna is configured so that a break in the mesh structure changes a signal provided from the antenna to the processing circuit when electromagnetic energy is received by the antenna.

Another embodiment relates to a system for monitoring a plurality of screen panels configured for use in a materials screening process. The system includes a plurality of screen panels. Each screen panel is coupled to a radio frequency identification (RFID) circuit which is configured to alter its behavior if its associated screen panel breaks. The system can further include a reader system having at least one transceiver configured to communicate with the RFID circuits of the plurality of screen panels, the reader system configured to determine if any of the screen panels are broken based on communication between the transceiver and the RFID circuits. The reader system may be configured to identify which of the screen panels are broken based on the communication.

Yet another embodiment relates to a system for monitoring an apparatus. The system includes a radio frequency identification (RFID) circuit. The system further includes a conductor system coupled to the apparatus and the RFID circuit, the conductor system configured to break when the apparatus breaks. The RFID circuit is configured to alter its behavior when the conductor system breaks.

Alternative exemplary embodiments relate to other features and combinations of features as may be generally recited in the claims.

### BRIEF DESCRIPTION OF THE FIGURES

The disclosure will become more fully understood from the following detailed description, taken in conjunction with the accompanying figures, wherein like reference numerals refer to like elements, in which:

FIG. 1 is a diagram of a system for monitoring parts such as screen panels used by a screening machine, according to an exemplary embodiment;

FIG. 2A is a top-down view of a screen panel, according to an exemplary embodiment;

FIG. 2B is a side view of the screen panel of FIG. 2A, according to an exemplary embodiment;

FIG. 2C is a top-down view of another screen panel, according to another exemplary embodiment;

FIG. 3 is a diagram of a system for monitoring parts used by a screening machine, according to an exemplary embodiment;

FIG. 4 is a flow chart of a process for monitoring screen panels used by a screening machine, according to an exemplary embodiment; and

FIG. 5 is an illustration of a screening machine having a plurality of break detectors (including an RFID circuit and a conductor system) for detecting mechanical breaks between structures of the screening machine.

### DETAILED DESCRIPTION

Referring to generally to the Figures, systems and methods for monitoring a plurality of screen panels configured for use in a materials screening process are shown. The system includes a plurality of screen panels. Each screen panel is coupled to a circuit (e.g., an radio frequency identification (RFID) circuit) which is configured to alter its behavior if its associated screen panel breaks (e.g., a structure of the screen panel fractures, one or more apertures of the screen panel becomes worn and too large, or the like).

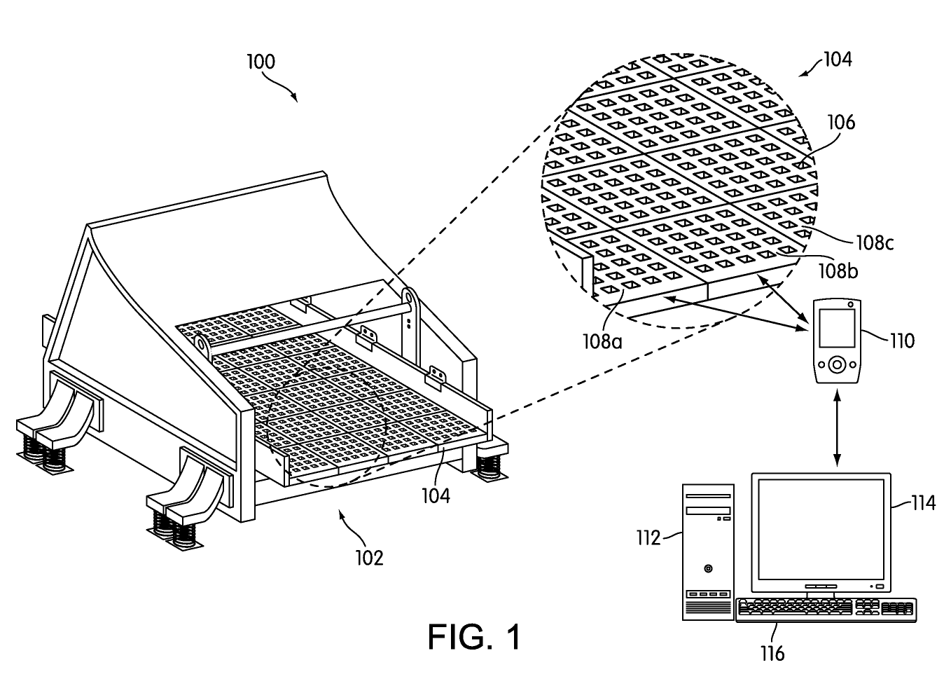

Referring now to FIG. 1, a system 100 for monitoring parts used by screening machine 102 is shown, according to an exemplary embodiment. Screening machine 102 is shown to include a screening deck 104. Screening machine 102 may operate by causing some (or all) of the material put onto screening deck 104 to move through apertures 106. Screening machine can cause the material to move through apertures 106 using any variety of methods (e.g., vibration, lateral movement of the material over the apertures, overhead pressure down on the material, gravity, any combination thereof, and/or any other method). According to an exemplary embodiment, a single screening machine may include multiple decks with each deck including at least one screen panel. The screen panels may be consistently sized and shaped across a single deck or multiple decks of one screening machine, or the screen panels may be sized and/or shaped differently across a single deck or multiple decks (e.g., multiple decks of a single screening machine). As shown in FIG. 1, for example, screening deck 104 is shown to include a plurality of screen panels 108a-108c.

According to an exemplary embodiment, each of screen panels 108a-108c are coupled to an antenna (e.g., a radio frequency identification (RFID) antenna) and are coupled to a processing circuit that is also coupled to the antenna. The antenna and processing circuit are configured to respond to wireless signals (e.g., RF signals) received from reader 110 at the antenna. Reader 110 can be configured to determine a status and/or a condition relating to screen panels 108a-108c based on responses (or the lack thereof) from the antenna/processing circuit pairs coupled to screen panels 108a-108c. For example, a high level of wear on one or more of the apertures of screen panel 108a may cause a circuit to break that disconnects the antenna from the processing circuit or otherwise causes its antenna and processing circuit pair not to respond to a query from reader 110. Reader 110, upon not receiving a response to its query, may determine that the one or more apertures 106 of screen panel 108a are broken (worn beyond a threshold, experiencing a mechanical facture, etc.). According to other exemplary embodiments, the processing circuit is configured to respond to reader 110 in a way that indicates one or more apertures of screen panel 108a are broken (rather than sending no response or being rendered inoperable due to the breakage).

Reader 110 can be further configured to communicate (e.g., wirelessly, via a wired connection, etc.) with one or more other systems or devices such as processing system 112 regarding the status and/or condition of the screen panels. Processing system 112 can be configured to aggregate and/or otherwise process the received information in any number of ways. For example, processing system 112 can maintain a database of the information to track statistics such as mean time to failure (MTTF), percentage of screening panels failing, a standard deviation relative to failure times, or any other measure or statistic relative to readings obtained by reader 110. Processing system 112 can include or be coupled to any number of user interface devices (e.g., keyboard 116) and an electronic display 114. Processing system 112 can cause, for example, a map or grid of screen panels of a screening machine deck to be displayed on the electronic display. The map can include status indications for the screen panels (e.g., failed, active, unknown, critical failure, near failure, etc.). Reader 110 can be a portable reader (as shown) or can be a stationary reader. Reader 110 can be coupled to or be a part of screening machine 102, can be operated by maintenance personnel or otherwise brought near screening machine 102 when diagnostics or maintenance is desired, or otherwise.

Screen panels 108a-108c are shown as arranged in a grid, but can be oriented differently according to various exemplary embodiments. Screen panels 108a-108c can be modular screen panels that couple to adjacent screen panels via any number of coupling mechanisms (e.g., pins, hooks, coupling edges, etc.). When a screening machine includes multiple decks, the screen panels can be configured differently, for example, to separate different sizes of materials by having differently sized apertures. Screen panels 108a-108c can be made from any number of materials (e.g., molded plastic, polyurethane, polyurethane-coated, rubber, rubber/plastic-coated wire, a composite material, a glass material, a ceramic material, a first material dipped in a second material such as vinyl, etc.) depending on the particular application for the screen panels. Screen panels 108a-108c can be rigid, semi-rigid, or flexible, depending on the material and application. Screen panels 108a-108c can be of any size or shape (e.g., eighteen inches by one foot, larger, smaller, square, rectangular, etc.) and a varying number of screening panels may be included in different screening decks (e.g., twenty four screening panels per deck, three hundred screening panels per deck, etc.).

While a single deck screening machine is shown in FIG. 1, it should be appreciated that many of the systems and methods described herein can be used in any screening machine (e.g., multi-deck, etc.) configured for any type of screening process (e.g., scalping, sizing, high moisture screening, dewatering, deliming, heavy media recovery, a trommel-based application, dry screening, wet screening, etc.) and having one or more screen panels.

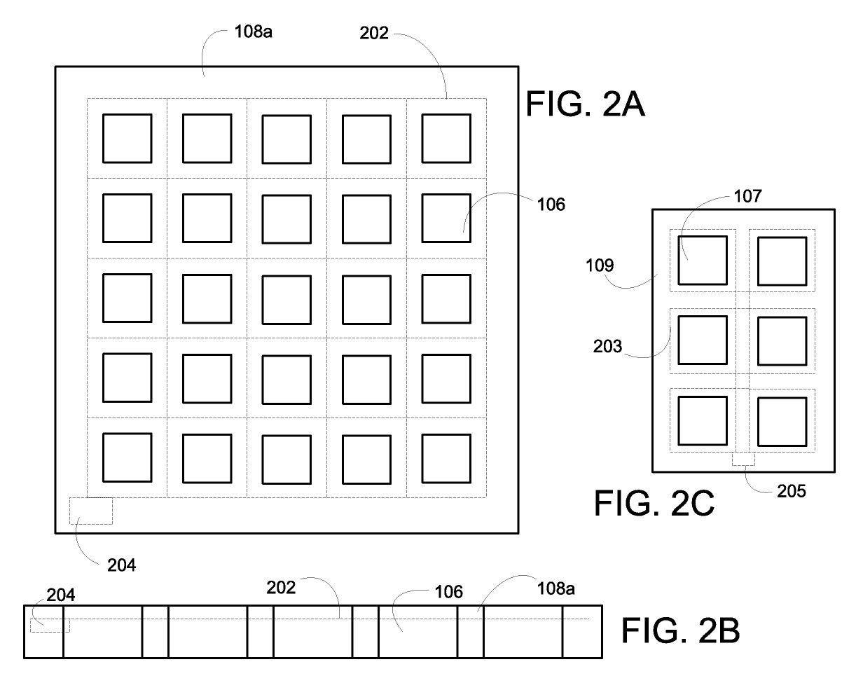

Referring now to FIGS. 2A and 2B, an overhead view and a side view of screen panel 108a are shown, respectively, according to an exemplary embodiment. Screen panel 108a is shown to include an array of apertures 106, a conductor system 202 and a processing circuit 204.

In the exemplary embodiment shown in FIGS. 2A and 2B, conductor system 202 forms one or more circuits that, when broken, will affect (directly or indirectly) the operation of processing circuit 204 relative to an electromagnetic query from reader 110 (shown in FIG. 1). Screen panel 108a is shown to include plurality of rows and columns of apertures and conductor system 202 is shown as embedded around a majority of the apertures of the screen panel. Accordingly, as wear occurs around the apertures or the material of screen panel 108a breaks, cracks, or otherwise fails, conductor system 202 may correspondingly fail or break to affect the operation of processing circuit 204 relative to signals from and/or to readers. Conductor system 202 may be configured in a variety of different ways and may be formed by a variety of different materials. For example, conductor system 202 may be a long continuous wire (e.g., copper, aluminum, silver, etc.), a system of connected wires, a system of disconnected wires, a system of electrically conducted traces of conductive material, or any other system which contains movable charges that can be used to detect wear or breakage in a screen panel. According to some exemplary embodiments, conductor system 202 is configured to surround less than a majority of the apertures (e.g., one aperture, two apertures, a plurality of apertures less than a majority, half the apertures, etc.). When less than a majority of the apertures are surrounded by a conductor system, the apertures that are surrounded (and thereby monitored) may be selected due to areas on the screen panel that typically fail earlier than other areas.

According to some exemplary embodiments, conductor system 202 forms at least a portion of the antenna that processing circuit 204 uses to receive or transmit electromagnetic energy (e.g., RF signals) from readers. Conductor system 202 may be configured to form a circuit that is or includes an antenna that will not successfully receive electromagnetic energy or transmit electromagnetic energy when broken. Even if conductor system 202 is able to receive electromagnetic energy if the circuit breaks, the conductor system may not communicate (accurately or at all) signals associated with the electromagnetic energy to processing circuit 204.

According to yet other exemplary embodiments, conductor system 202 forms a circuit which the processing circuit is configured to monitor for a status condition. In such embodiments, processing circuit 204 may be associated with an antenna configured to operate even if conductor system 202 is broken or otherwise affected by wear. When the processing circuit detects a status condition change, the processing circuit may be configured to alter information provided to a reader in response to the query based on the status condition change. For example, the processing circuit may be configured to format and send messages that represent status conditions such as “a first level of wear is detected” or “complete failure is detected.”

Processing circuit 204 is shown in FIGS. 2A and 2B as embedded within screen panel 108a and coupled to conductor system 202. Processing circuit 204 can be, include, or be a part of a radio frequency identification (RFID) circuit (e.g., RFID tag, RFID transponder, etc.). Processing circuit 204 can be an integrated circuit configured to store information and/or to process signals received from an antenna (e.g., conductor system 202) or another antenna coupled to the processing circuit). Processing the signals may include demodulating received signals, determining a response to the demodulated received signals, generating the response, modulating the response for transmission via the antenna coupled to the processing circuit, providing the modulated response to the antenna, and/or any other related processing activities.

Processing circuit 204 may be, include, or be a part of a passive RFID circuit or an active RFID circuit. Accordingly, screen panel 108a may include or be coupled to a power source (e.g., a battery) configured to provide power to processing circuit 204 when the processing circuit is an active RFID circuit. In embodiments where processing circuit 204 is a passive RFID circuit, screen panel 108a may not include or be coupled to a power source and instead use power available from a received signal to modulate the response (e.g., control reflected power, modulate backscatter, etc.). When the RFID circuit is an active circuit, conductor system 202 can be electrically “between” (directly or indirectly) the power source and the processing circuit such that a break of the circuit portion formed by conductor system 202 causes the power to the processing circuit to be turned off (or otherwise unavailable). When the RFID circuit is a passive circuit then conductor system 202 can be electrically “between” (directly or indirectly) the RFID circuit and an antenna (or antenna portion) that captures electromagnetic energy for powering the processing circuit. In such a system, a break of the conductor system causes power from the antenna to the processing circuit to be unavailable.

Processing circuit 204 may be coupled to or include an energy harvesting circuit configured to convert physical energy into electrical energy. The converted energy may be stored in a battery coupled to the energy harvesting circuit. Due to the frequent vibration of the screening machine and the screening panels on the screening machine, each screening panel may include an energy harvesting circuit configured to convert the vibrational energy available to the energy harvesting circuit to electrical energy. For such an application, the energy harvesting circuit may include one or more piezoelectric elements configured to be stimulated by the vibration of the screening panels. In other embodiments, each screening panel may include an electromagnetic generator where a magnet is caused to move relative to a conductor (e.g., a coil) due to the screening panel vibrations to induce an electrical current in the conductor. In yet other embodiments, each screening panel may include one or more variable capacitors or transducers configured so that the vibrations of the screening panels frequently separate and bring together plates of the variable capacitor or transducer so that the vibrational energy is converted into electrical energy via the changing capacitance of the variable capacitor or transducer. It should be noted that any combination of energy harvesting technologies may be incorporated into the screening panels so that processing circuit 204 can be powered for RF communications. Further, processing circuit 204 can be configured with a passive RF circuit portion in addition to energy harvesting or active components. For example, a first signal received from a reader may provide enough power to a passive portion of processing circuit 204 to cause the processing circuit to turn on or “power-up” for active communications with the reader.

Referring now to FIG. 2C, an top-down illustration of a screen panel 109 is shown, according to an exemplary embodiment. Screen panel 109 is shown to include an aperture array that is two apertures 107 wide by three apertures 107 deep. By contrast to conductor system 202 shown in FIG. 2A, conductor system 203 is configured differently. For example, conductor system 203 is shown as more closely surrounding the apertures (e.g., so that wear can be detected earlier) and the individuals lines (e.g., wires, traces) of conductor system 203 are provided near and along the aperture edges (e.g., not along the center line between adjacent apertures as shown in FIG. 2A). Different conductor system configurations can be selected for different purposes. For example, if detecting only significant breakage of the screen panel structure is goal of the monitoring system then a center-line orientation of the conductor system may be used. If tolerances of the screening application are small and it is desirable to detect a certain amount of wear around the apertures then the conductor system may be disposed very near the aperture edges or at least off-center of the line between two adjacent apertures. According to yet other exemplary embodiments, it should be noted that multiple conductors may surround one or more apertures of a screen panel. For example, a single aperture may have two conductors surrounding the aperture, one conductor that, when broken, indicates a first level of wear and a second conductor that, when broken, indicates a second level of wear. In this case, the first conductor may be spaced closer to the edge of the aperture (e.g., horizontally and/or vertically) than the second conductor.

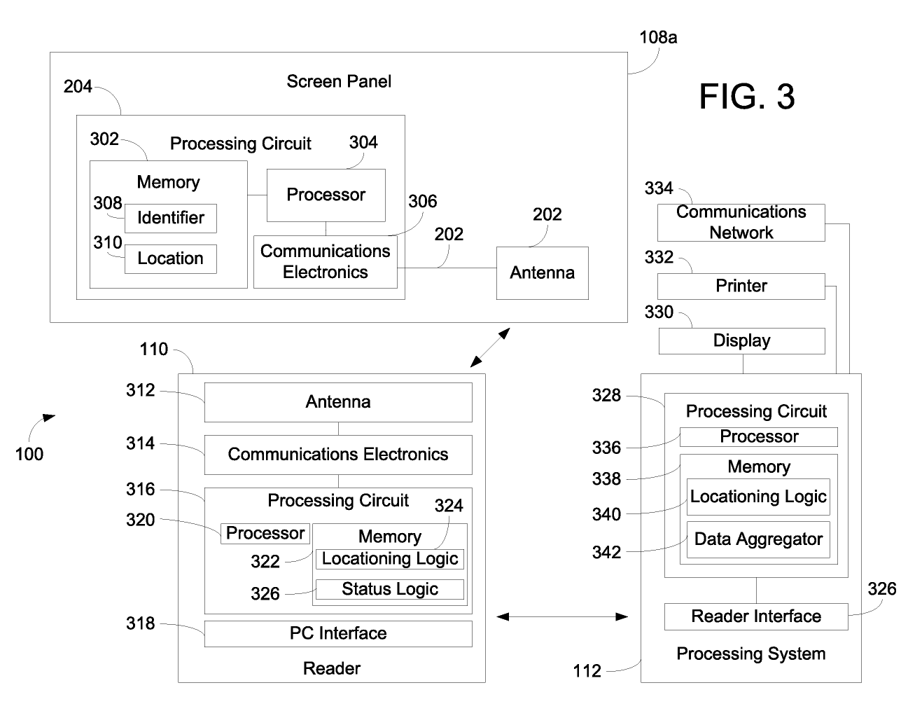

Referring now to FIG. 3, a detailed block diagram of system 100 shown in FIG. 1A is shown, according to an exemplary embodiment. Screen panel 108a is shown to include processing circuit 204 and conductor system 202. As noted, conductor system 202 can be between the processing circuit and the antenna and/or can be an antenna. Processing circuit 204 communicates with reader 110 via antenna 202. Processing circuit 204 is shown to include memory 302, processor 304, and communications electronics 306. Communications electronics 306 can be or include a transceiver (i.e., a transmitter and receiver), can be the hardware interface between processor 304 and antenna 202, and/or can be any collection of hardware/software components configured to facilitate the use of antenna 202 by processor 304.

It should be noted that while RFID is mentioned as a technology that may be used with the systems and methods of the present disclosure, a variety of different wireless technologies could be used for the query and response activities of the reader and/or screen panels. For example, ZigBee, Bluetooth, an IEEE 802.11 protocol, a cellular protocol, or any other standard or proprietary communications protocol may be used by processing circuit 204 and/or antenna 202 to communicate wirelessly with a reader. Further, the wireless activities of the reader and/or the circuits of the screen panels may be configured to communicate via any number of different network or communication topologies (e.g., point-to-point, mesh, broadcast, multicast, etc.). Yet further, processing circuit 204 and/or antenna 202 can be configured to operate within one or more frequency bands. The bandwidth and/or frequency band may change based on the number of systems used in a certain facility, materials used in the screening machine, and the like. For example, in some systems a low-frequency range between 125-134.2 kHz may be used while in other systems it might be optimal to utilize a much higher frequency range (e.g., 868-928 MHz). It should further be appreciated that different communication frequencies may be available or unavailable in one or more countries due to communications regulations and that the processing circuit 204 and/or antenna 202 may be configured accordingly. Further, it should be appreciated that a number of different power levels may be utilized by the reader and/or by processing circuit 204 and/or antenna 202. In some situations where reliable transmission over a relatively long distance is required, it may be desirable to provide a high power transceiver at the reader and/or to provide a relatively highly powered circuit on the screen panel side. If transmission ranges of less than one foot are possible, induction field communication (e.g., near field communication (NFC)) may be used rather than a form of radiation field communication (e.g., far field communication). If near field communication is used and transmission ranges are small (e.g., less than six inches), a screening machine may be adapted to include a reader that mechanically “scans” over all of its screen panels in a pattern (e.g., via a moving arm coupled to the screening machine). According to an exemplary embodiment, and whether or not near field communication is used, this mechanical scanning may be used to “map” or otherwise determine the location of individual screen panels on a screening deck.

Referring back to FIG. 3, processor 304 is shown coupled to memory 302 and can be configured to store and/or retrieve information contained in memory 302. Memory 302 can be flash memory, ROM, RAM, solid state memory of another type, or any other type of memory. Memory 302 can be integrated with processor 304 in some exemplary embodiments. As shown, memory 302 can be configured to store an identifier 308 (e.g., identifying information), and a location 310 (e.g., location information) that processing circuit 204 can cause to be communicated to reader 110. Identifier 308 can be a unique string of information (e.g., bits, characters, numbers, etc.) that can be used to identify screen panel 108a relative to other screen panels (e.g., in a given machine, in use by a single owner, ever produced by a manufacturer, etc.). Location 310 can be a coordinate or another location identifier/descriptor relative to a fixed geophysical location, a location in a screening deck, or relative to any other system for identifying the location of screen panel 108a. For example, screening decks may be arranged in a grid with letters to identify a row and numbers to identify a column. In this example, location 310 stored in memory may be “B3” and when read by reader 110 and/or displayed or otherwise reported to a user, the system and/or user may easily derive the physical location of the screen panel relative to the other screen panels on the screening deck. It should be noted that reader 110 and/or another electronic device may be used to provide and/or update identifier 308 or location 310 of screen panel 108a. For example, during an initial installation into a screening machine, an installer can utilize a device such as reader 110 to assign an identifier and a location to each screen panel of the machine. According to other exemplary embodiments, only identifier 308 is stored in screen panel 108a and the identifier is used by reader 110 or another device to build a record (e.g., a database) of screen panel locations. The database may associate screen panel identifiers with fields such as screening machine, location, in-service date, and the like.

Referring further to FIG. 3, reader 110 is shown to include antenna 312, communications electronics 314, processing circuit 316, and PC interface 318. Processing circuit 316 includes processor 320 and memory 322. Processing circuit 316 can be configured to query one or more screening panels at a time by controlling communications electronics 314 and antenna 312. This query may be conducted by, for example, sending a broadcast message that challenges any receiving screen panels (i.e., the circuits/antennas thereof) to respond with an acknowledgement message, an identifier, a location, and/or any other information. When information is received by reader 110 from one or more screening panels, processing circuit 316 of reader 110 can be configured to conduct a number activities relating to the status of the screening panels. According to an exemplary embodiment, processor 320 uses status logic 326 to derive a screen panel status for reporting to another device or for reporting to a user (e.g., via an electronic display of the reader). In some embodiments, status logic 326 will wait an amount of time to receive responses to a query from reader 110. After the amount of time has lapsed, status logic 326 may determine that each screen panel that did not respond should be manually inspected for breakage (e.g., wear or other breakage that has caused the screen panel's electronics to cease working). Memory 322 is further shown to include locationing logic 324 which may be configured to determine and/or assign a location for each screen panel of a screening deck. The determination may be conducted by, for example, operating reader 110 in a very short range mode of operation and “scanning” each screen panel as the screen panel is installed in a screening deck. Locationing logic 324 can read the identifiers that are received as a result of the scanning and build a “map,” “grid,” or other location scheme using the read identifiers. Location may also be input by a user of reader 110 via a user interface associated with reader 110 (e.g., a touch screen, a keypad, etc.). For example, reader 110 may provide a user with a display of a grid for a screening deck and allow the user to click on each grid location and to associate a screen panel identifier with each grid location.

Reader 110 is further shown to include PC interface 318 configured for communications with processing system 112 or other computing systems. PC interface 318 may be or include a wireless transceiver (e.g., a Bluetooth transceiver, a WiFi transceiver), a USB terminal, a firewire terminal, an Ethernet jack, and/or any other hardware/software for functionally connecting reader 110 to processing system 112. Processing system 112 can include a reader interface 326 (e.g., wireless transceiver, optical interface, a USB terminal, a firewire terminal, etc.) with which PC interface 318 communicates. Reader interface 326 provides information from reader 110 to processing circuit 328. Processing system 112 can be configured to conduct the processing activities described above with reference to reader 110. For example, memory 338 of processing circuit 328 is shown to include locationing logic 340 which may be configured similarly to locationing logic 324 of reader 110. Processing circuit 328 can provide the results of its processing to display 330, printer 332, communications network 334, or to any other device local to or remote from processing system 112. For example, processing circuit can be configured to generate a report regarding which screen panels should be serviced and to provide the generated report to communications network 334 for viewing by a remote web browser, to display 330 for viewing on a local electronic display, and/or to printer 332 for printing. Processor 336 can be a general purpose processor, an ASIC, or any other suitable processor for executing and/or facilitating the execution of the activities described with reference to processing system 112. Data aggregator 342 may be a module (e.g., a computer code function, a computer code section, etc.) configured to aggregate data processing system 112 receives from one or more readers 110. Data aggregator 342 can be configured to store, calculate, and track historical information regarding screen panels (e.g., determine locations of screening decks that fail more often than others, determine the mean time before failure for screen panels, track in-service dates for particular screen panels, estimate a failure data for screen panels based on historical data, etc.).

Referring still to FIG. 3, processing system 112 can be configured to provide information (e.g., relating to screen panel breakage, etc.) to a remote server 336 via, for example, communications network 334. Network 334 can be one or more local networks, wide area networks, the Internet, a wireless network, a cellular network, a satellite network, or any combination thereof. According to an exemplary embodiment, processing system 112 includes one or more sets of communications electronics for communicating on network 334. For example, processing system 112 can include an Ethernet port and associated electronics for communicating on an Ethernet-based LAN or WAN (which may be connected to another network such as the Internet). In other embodiments, processing system 112 can include or be coupled to a cellular modem for communicating with a cellular network. Processing system 112 can periodically transmit data to remote server 336 or may only “push” new information to remote server 336 when a state changes (e.g., when a screen panel is detected to have broken). In other exemplary embodiments, remote server 336 can be configured to poll or query processing system 112 (e.g., at regular intervals, in response to a user request at remote client 338 for information, etc.) for changed values or other pertinent information. Processing system 112 can be configured to provide monitoring features in addition to monitoring for the status of screen panels. For example, processing system 112 can be communicably coupled to temperature sensors, vibration sensors, feeder controls, and/or any other sensors or control feedbacks (e.g., that may be physically coupled to/at the screening machine). Processing system 112 can be configured to send notifications of events to remote server 336 and/or can be configured to continuously send “logged” data to remote server 336. The communication pairing between processing system 112 and remote server 336 can be via web services (e.g., a web service running on processing system 112 can provide information to another web service or web server running on remote server 336). For example, a secure PHP-based website running on remote server 336 may be configured to receive the monitoring data or the logged data from processing system 112. The website can also be used to provide remote client 338 with graphical user interfaces or other information for viewing at an electronic display. Remote server 336 can be configured to generate user interfaces for display on client 338 that allow a user of client 338 to setup the system, to visually monitor events, or to perform any other function relating to the data received at or available to remote server 336. According to some exemplary embodiments, processing system 112 can be an embedded Windows XP system. Processing system 112 can be a CP-3 Telemetry Sentinel sold by Schenck Process, GmbH. According to an exemplary embodiment, processing system 112 and/or remote server 336 can be configured to send messages to other remote devices (e.g., mobile phones, pagers, etc.) by generating and sending an e-mail address, text message, or other message for receipt by the devices. For example, when a screen panel breaks and the breakage is detected by processing system 112, processing system 112 and/or remote server 336 can be configured to generate an e-mail and to send the e-mail to an e-mail address associated with personnel responsible for the relevant screening machine.

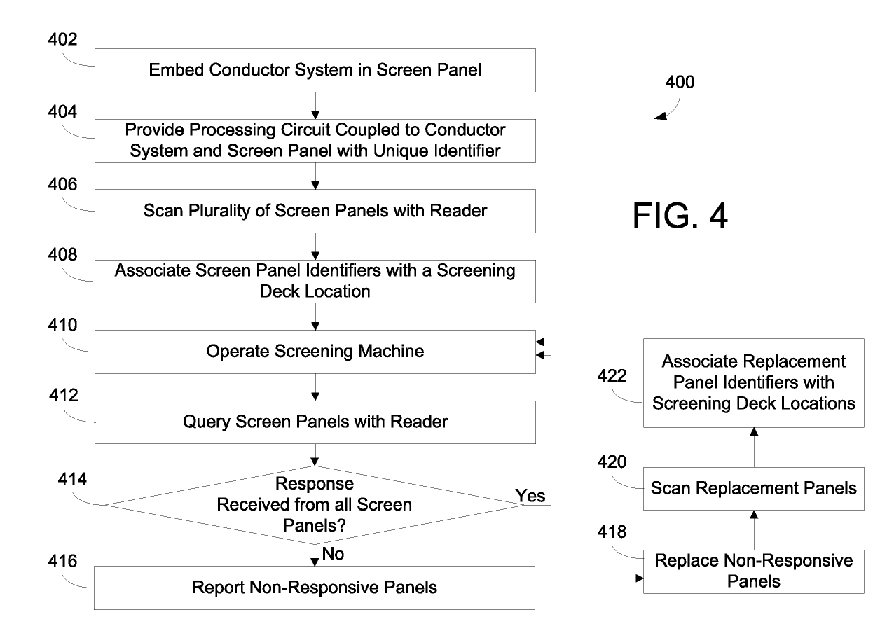

Referring now to FIG. 4, a flow chart of a process 400 for monitoring a status of a screen panel configured for use in a materials screening process is shown, according to an exemplary embodiment. Process 400 is shown to include the step of embedding a conductor system in a screen panel (step 402). As mentioned above, in some alternative embodiments the conductor system may be other than embedded in the screen panel (e.g., bonded to the screen panel, molded to the screen panel, fused to the screen panel, printed to the screen panel, etc.). Step 402 may also include coupling a processing circuit (e.g., an RFID circuit) to the conductor system and the screen panel. Process 400 is further shown to include providing the processing circuit a unique identifier (step 404). Once one or more of the panels are placed into the screening deck (or otherwise installed where they will be used), the one or more panels can be scanned by a reader (step 406) and screen panel identifiers can be associated with a screening deck location (step 408). This association can be automatic (e.g., the reader can calculate the position of the panels) or can be manual (e.g., the user can enter a location after or before each panel is scanned). The association can be conducted once the screen panels are installed into the screening machine or can be updated as one or more screen panels are being installed in the screening machine (e.g., as the deck is being assembled). Once all screen panels are scanned for a deck, the screening machine can be operated (e.g., for one or more cycles, days, weeks, months, etc.)(step 410). During or after a cycle of operation, the screen panels can be queried using the reader (step 412). The query may be conducted according to a maintenance schedule, according to cycle beginnings and/or ends, continuous (e.g., conducted frequently during a cycle) or otherwise. Depending on the configuration of the screen panels, their circuits, and conductor systems, varying responses (or no responses) may be received from the panels within range of the reader. According to a preferred embodiment, a break in the panel (or too much wear) causes a corresponding break in the conductor system which thereby causes the screen panel to be non-responsive to queries. Accordingly, in FIG. 4, step 414 includes determining if a response has been received from all screen panels. If a response has been received from all screen panels, process 400 is shown to loop back to operation of the screening machine for some period of time. If a response is not received from all screen panels (e.g., all screen panels that are expected to report back after a query), the non-responsive screen panels can be reported (step 416) to the user and/or another system (e.g., processing system 112). Process 400 is further shown to include replacing the non-responsive panels on the screening deck or in the screening machine (step 418). The replacement panels can then be scanned (step 420) and their identifiers associated with screening deck locations (step 422). The process is then shown to loop back to step 410, operating the screening machine.

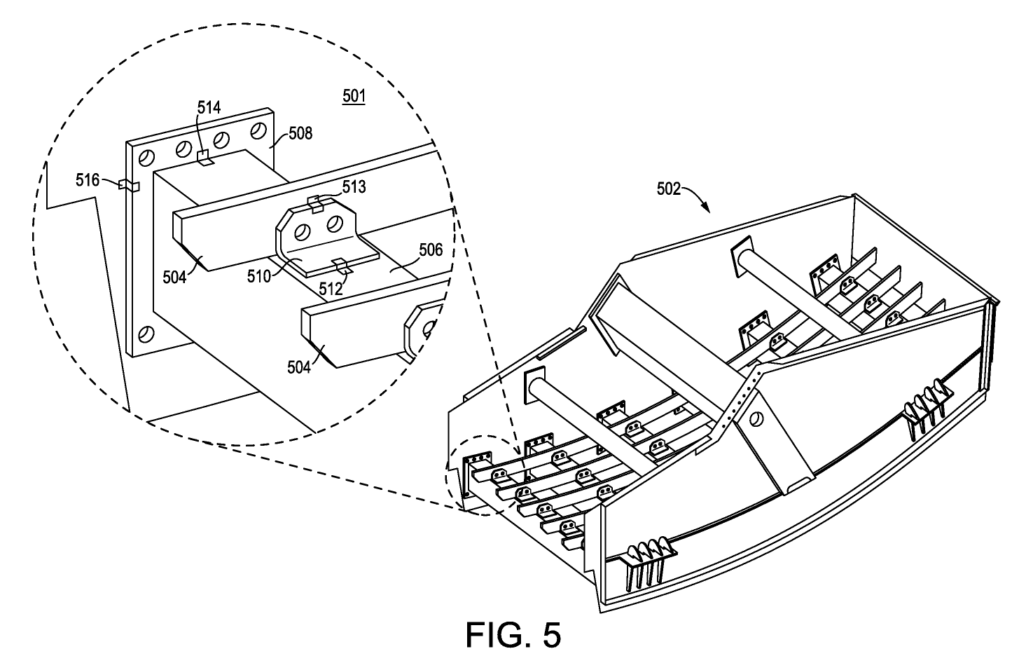

Referring now to FIG. 5, screening machine 502 is shown partially constructed and without any screening panels forming a screening deck. Screening panels, when screening machine 502 is fully constructed, will be placed and connected to the top of deck rails 504. Deck rails 504 are secured to machine 502 by a mechanical coupling to cross beams 506. Cross beams 506 are secured to side wall 501 of screening machine 502 via side wall bracket 508. Deck rails 504 are shown as secured to cross beam 506 by cleat 510 (e.g., bracket, brace, retaining member, etc.). According to an exemplary embodiment, cleat 510 is welded to cross beam 506 and bolted to deck rail 504.

Abnormal screening machine behavior can occur if cleat 510 breaks away from cross beam 506 and/or deck rail 504. Similarly, abnormal screening machine behavior can occur if cross beam 506 and/or side wall bracket 508 breaks away from side wall 501. Break detector 512 is shown coupled to cross beam 506 and to cleat 510. Break detector 512 can be or include an RFID circuit (or other wireless technology) configured to alter its behavior if a break in break detector 512 occurs. For example, break detector 512 can include a conductor system and/or antenna that spans the length of break detector 512. If the weld between cleat 510 and cross beam 506 breaks such that cleat 510 and cross beam 506 separate, break detector the conductor system and/or antenna of break detector 512 can be configured to break. Similar to the embodiments described above with reference to FIGS. 1-4, a break of the antenna and/or conductor system can cause the RFID circuit to stop working or to respond in a way that a reader can interpret as corresponding to a mechanical break. The conductor system spanning the joint between cleat 10 and cross beam 506 can be or include a single conductor, a pattern of conductors, or any other configuration of conductor. For example, the conductor system may form a loop antenna. The conductor system can be on or embedded within a non-conductive substrate such as that of a flexible circuit, a flexible ribbon, or the like. According to an exemplary embodiment, break detector 512 can be adhered to deck rail 504 and cross beam 506 with an adhesive. In other embodiments, one or more of the couplings can be made, for example, by a small screw, a bolt, a tab, or another physical link between the break detector and the structure to which the break detector is attached.

In the embodiment shown in FIG. 5, in addition to break detector 512, break detectors 513, 514, and 516 are provided on screening machine 502. Break detector 513 spans a juncture between deck rail 504 and cleat 510. Break detector 514 spans a juncture between cross beam 506 and side wall bracket 508. Break detector 516 spans a juncture between side wall bracket 508 and side wall 501. Break detectors 512-516 can be covered by a bead of silicon or another non-conductor that can protect the break detector from impact and/or moisture. According to an exemplary embodiment, break detectors 512-516 can be logically associated with a location on screening machine 502. The logical associations, for example, can be stored in processing system 112 shown in previous Figures. Cleat 510 shown in FIG. 5, for example, could be associated with the first deck rail at the first cross beam and memory (e.g., of processing system 112) could store A:A or a similarly self-descriptive identifier in a memory location corresponding to break detector 512 and break detector 513. If the processing system 112 determines that a break has occurred at location A:A, this determination can be communicated to a user so that location A:A can be inspected for damage. It should be appreciated that the break detectors described with reference to FIG. 5 can incorporate a number of the details described above with reference to the systems of the screening panels. For example, the same reader that is used to wireless information from circuits within screening panels can be used to read the break detectors shown in FIG. 5.

The systems and methods as shown in the various exemplary embodiments are illustrative only. Although only a few embodiments have been described in detail in this disclosure, many modifications are possible. For example, while the entire panel can be monitored for breakage and that breakage detected, the conductor system/antenna may be configured to cover at least two areas of the screen panel and the processing circuit may be configured to identify which of the two areas is malfunctioning based on the signal received at the processing circuit from the conductor system/antenna.

Further, it should be appreciated that the systems and methods described herein can be adapted for applications beyond the screen panels. For example, the cross-beam cleats (e.g., weld points) of a screening machine can be adapted to include or be coupled to a conductor system or antenna such that when the cross-bream cleat (or weld point) breaks, the conductor system, antenna, and/or processing circuit will cease to operate in a first way when queried by a reader.

The position of elements may be reversed or otherwise varied and the nature or number of discrete elements or positions may be altered or varied. All such modifications are intended to be included within the scope of the present disclosure. The order or sequence of any process or method steps may be varied or re-sequenced according to alternative embodiments. Also two or more steps may be performed concurrently or with partial concurrence. Such variation will depend on the software and hardware systems chosen and on designer choice. All such variations are within the scope of the disclosure. Likewise, software implementations could be accomplished with standard programming techniques with rule based logic and other logic to accomplish the various connection steps, processing steps, comparison steps and decision steps. Other substitutions, modifications, changes, and omissions may be made in the design, operating conditions and arrangement of the exemplary embodiments without departing from the scope of the present disclosure.

Embodiments within the scope of the present application include program products comprising machine-readable media for carrying or having machine-executable instructions or data structures stored thereon (e.g., program products for the reader and/or the processing systems described herein, program products for installation and/or embedding within the processing circuits of the screen panels, etc.). Such machine-readable media can be any available media that can be accessed by a general purpose or special purpose computer or other machine with a processor. By way of example, such machine-readable media can comprise RAM, ROM, EPROM, EEPROM, CD-ROM or other optical disk storage, magnetic disk storage or other magnetic storage devices, or any other medium which can be used to carry or store desired program code in the form of machine-executable instructions or data structures and which can be accessed by a general purpose or special purpose computer or other machine with a processor. When information is transferred or provided over a network or another communications connection (either hardwired, wireless, or a combination of hardwired or wireless) to a machine, the machine properly views the connection as a machine-readable medium. Thus, any such connection is properly termed a machine-readable medium. Combinations of the above are also included within the scope of machine-readable media. Machine-executable instructions comprise, for example, instructions and data which cause a general purpose computer, special purpose computer, or special purpose processing machines to perform a certain function or group of functions.

What is claimed is:

1. A system for monitoring a status of a screen panel configured for use in a material screening process, the system comprising:
a screen panel configured for use in the material screening process;
an antenna coupled to the screen panel and configured to receive first electromagnetic energy; and
a processing circuit coupled to the screen panel and the antenna, the processing circuit configured to receive a signal from the antenna regarding the first electromagnetic energy and to cause the transmission of second electromagnetic energy in response to the receipt of the signal.

2. The system of claim 1, wherein the antenna is embedded within the screen panel.

3. The system of claim 1, wherein the screen panel is arranged to include a plurality of rows and columns of apertures and wherein a conductor system for the antenna is embedded around at least one of the apertures of the screen panel.

4. The system of claim 1, wherein the screen panel is arranged to include a plurality of rows and columns of apertures and wherein a conductor system for the antenna is embedded around a majority of the rows and columns of the apertures of the screen panel.

5. The system of claim 4, wherein the conductor system of the antenna forms a circuit which will not successfully receive the first electromagnetic energy and/or transmit the second electromagnetic energy when a portion of the screen panel is broken.

6. The system of claim 4, wherein the conductor system of the antenna forms a circuit which the processing circuit is configured to monitor for a status condition, wherein the processing circuit is configured to alter information represented by the second electromagnetic energy based on the status condition.

7. The system of claim 4, wherein the conductor system of the antenna forms a circuit, and wherein the processing circuit is configured to alter its operation if the circuit is broken.

8. The system of claim 1, wherein the screen panel is a screen configured to allow the material to flow and/or fall through openings formed by the screen, wherein the screen is formed from at least one of plastic, rubber, ceramic, and glass.

9. The system of claim 1, wherein the processing circuit is assigned a unique identifier that is communicated with the second electromagnetic energy in response to the receipt of the signal.

10. The system of claim 1, wherein the antenna and the processing circuit form a passive radio frequency identification (RFID) circuit.

11. The system of claim 1, wherein the processing circuit is coupled to a power supply and the antenna and the processing circuit form an active radio frequency identification (RFID) circuit.

12. The system of claim 1, further comprising:
a reader located remotely from the screen panel and configured to transmit the first electromagnetic energy to the antenna, wherein the reader is configured to determine the status of the screen panel based on one of:
(a) whether the second electromagnetic energy is received by the reader; and
(b) information represented by second electromagnetic energy received by the reader.

13. The system of claim 12, wherein the reader is configured to monitor for radio frequency (RF) responses from a plurality of antennas and processing circuits coupled to a plurality of screen panels.

14. The system of claim 13, wherein the reader is configured to identify one or more broken screen panels based on received RF responses.

15. The system of claim 13, wherein the reader is configured to identify one or more broken screen panels based on which screen panels having antennas and processing circuits do not return RF responses to the reader.

16. The system of claim 13, wherein the reader is configured to provide data regarding the broken screen panels to a processing system configured to communicate at least one of the identification and the location of the broken screen panels to a user.

17. The system of claim 13, wherein the reader is configured to build a map of screen panels based on responses received from the screen panels.

18. A screen panel configured for use in a materials screening process, comprising:
a mesh structure;
an antenna embedded within the mesh structure; and
a processing circuit coupled to the mesh structure and the antenna,
wherein the antenna is configured so that a break in the mesh structure changes a signal provided from the antenna to the processing circuit when electromagnetic energy is received by the antenna.

19. A system for monitoring a plurality of screen panels configured for use in a materials screening process, the system comprising:
a plurality of screen panels, wherein each screen panel is coupled to a radio frequency identification (RFID) circuit which is configured to alter its behavior if its associated screen panel breaks.

20. The system of claim 19, wherein each screen panel is arranged to include a plurality of rows and columns of apertures and a conductor system for an antenna is embedded around a plurality of the apertures of the screen panel, wherein the RFID circuit altering its behavior if its associated screen panel breaks comprises experiencing a break in the conductor system that affects the RFID circuit's operation.

21. The system of claim 20, further comprising:
a reader system having a transceiver configured to communicate with the RFID circuits of the plurality of screen panels, the reader system configured to determine if any of the screen panels are broken based on communication between the transceiver and the RFID circuits.

22. The system of claim 21, wherein the reader system is further configured to identify which of the screen panels are broken based on the communication.

23. A system for monitoring an apparatus, the system comprising:
a radio frequency identification (RFID) circuit; and
a conductor system coupled to the apparatus and the RFID circuit, the conductor system configured to break when the apparatus breaks, wherein the RFID circuit is configured to alter its behavior when the conductor system breaks.
